(19) United States
(12) Patent Application Publication
(10) Pub. No.: US 2019/0176321 A1
(43) Pub. Date: Jun. 13, 2019

(54) ROBOTIC FLOOR-CLEANING SYSTEM MANAGER

(71) Applicant: AI Incorporated, Toronto (CA)

(72) Inventors: Ali Ebrahimi Afrouzi, Toronto (CA); Soroush Mehrnia, Toronto (CA)

(21) Appl. No.: 16/277,991

(22) Filed: Feb. 15, 2019

Related U.S. Application Data
(63) Continuation-in-part of application No. 15/272,752, filed on Sep. 22, 2016.
(60) Provisional application No. 62/235,408, filed on Sep. 30, 2015.
(60) Provisional application No. 62/272,004, filed on Dec. 28, 2015.
(60) Provisional application No. 62/661,802, filed on Apr. 24, 2018.
(60) Provisional application No. 62/631,050, filed on Feb. 15, 2018.
(60) Provisional application No. 62/735,137, filed on Sep. 23, 2018.
(60) Provisional application No. 62/666,266, filed on May 3, 2018.
(60) Provisional application No. 62/667,977, filed on May 7, 2018.
(60) Provisional application No. 62/631,157, filed on Feb. 15, 2018.
(60) Provisional application No. 62/658,705, filed on Apr. 17, 2018.
(60) Provisional application No. 62/637,185, filed on Mar. 1, 2018.
(60) Provisional application No. 62/681,965, filed on Jun. 7, 2018.

(51) Int. Cl. B25J 9/00; B25J 11/00; B25J 9/16

(52) U.S. Cl. CPC B25J 9/0003; B25J 9/1666; B25J 11/0085

(57) ABSTRACT

Provided is a process that includes, obtaining a map of a working environment of a robot; presenting a user interface having inputs by which, responsive to user inputs, modes of operation of the robot are assigned to areas of the working environment depicted in the user interface; receiving a first set of one or more inputs via the user interface, wherein the first set of one or more inputs: designate a first area of the working environment, and designate a first mode of operation of the robot to be applied in the designated first area of the working environment; and after receiving the first set of one or more inputs, causing the robot to be instructed to apply the first mode of operation in the first area of the working environment.

### CROSS-REFERENCE TO RELATED APPLICATIONS

This patent filing is a continuation-in-part of U.S. patent application Ser. No. 15/272,752 filed Sep. 26, 2016 which is a Non-Provisional Patent Application of U.S. Provisional Patent Application Nos. 62/235,408 filed Sep. 30, 2015 and 62/272,004 filed Dec. 28, 2015, each of which is hereby incorporated by reference.

This patent filing claims the benefit of Provisional Patent Application Nos. 62/661,802 filed Apr. 24, 2018; 62/631,050 filed Feb. 15, 2018; 62/735,137 filed Sep. 23, 2018; 62/666,266 filed May 3, 2018; 62/667,977 filed May 7, 2018; 62/631,157 filed Feb. 15, 2018; 62/658,705 filed Apr. 17, 2018; 62/637,185 filed Mar. 1, 2018; and 62/681,965 filed Jun. 7, 2018, each of which is hereby incorporated by reference.

In this patent, certain U.S. patents, U.S. patent applications, or other materials (e.g., articles) have been incorporated by reference. Specifically, U.S. patent application Ser. Nos. 15/272,752, 15/949,708, 16/048,179, 16/048,185, 16/163,541, 16/163,562, 16/163,508, 16/185,000, 62/681,965, 62/614,449, 16/109,617, 16/051,328, 15/449,660, 16/041,286, 15/406,890, 14/673,633, 16/163,530, 62/735,137, 62/746,688, 62/740,573, 62/740,580, 15/614,284, 15/955,480, 15/425,130, 14/817,952, 16/198,393, 62/590,205, 62/740,558, 16/239,410, 16/230,805, 16/129,757, 16/245,998, 16/243,524, 16/261,635, and 16/127,038 are hereby incorporated by reference. The text of such U.S. patents, U.S. patent applications, and other materials is, however, only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

### FIELD OF THE DISCLOSURE

This disclosure relates to a method and computer program product for graphical user interface (GUI) organization control for robotic devices.

### BACKGROUND

Robotic devices are increasingly used to clean floors, mow lawns, clear gutters, transport items and perform other tasks in residential and commercial settings. Many robotic devices generate maps of their environments using sensors to better navigate through the environment. However, such maps often contain errors and may not accurately represent the areas that a user may want the robotic device to service. Further, users may want to customize operation of a robotic device in different locations within the map. For example, a user may want a robotic floor-cleaning device to service a first room with a steam cleaning function and service a second room with a vacuuming function. A need exists for a method for users to adjust a robotic floor-cleaning map and control operations of a robotic floor-cleaning device in different locations within the map.

### SUMMARY

The following presents a simplified summary of some embodiments of the present techniques. It is not intended to limit the inventions to embodiments having any described elements of the inventions or to delineate the scope of the inventions. Its sole purpose is to present some embodiments of the invention in a simplified form as a prelude to the more detailed description that is presented below.

Some aspects relate to a process, including obtaining, with an application executed by a communication device, from a robot that is physically separate from the communication device, a map of a working environment of the robot, the map being based on data sensed by the robot while traversing the working environment; presenting, with the application executed by the communication device, a user interface having inputs by which, responsive to user inputs, modes of operation of the robot are assigned to areas of the working environment depicted in the user interface; receiving, with the application executed by the communication device, a first set of one or more inputs via the user interface, wherein the first set of one or more inputs: designate a first area of the working environment, and designate a first mode of operation of the robot to be applied in the designated first area of the working environment; and after receiving the first set of one or more inputs, causing, with the application executed by the communication device, the robot to be instructed to apply the first mode of operation in the first area of the working environment.

### BRIEF DESCRIPTION OF DRAWINGS

FIG.1 illustrates the process of generating a map and making changes to the map through a user interface in some embodiments.

FIG.2 illustrates the process of selecting settings for a robotic floor-cleaning device through a user interface in some embodiments.

FIG. 3A illustrates a plan view of an exemplary workspace in some use cases.

FIG. 3B illustrates an overhead view of an exemplary two-dimensional map of the workspace generated by a processor of a robotic floor-cleaning device in some embodiments.

FIG. 3C illustrates a plan view of the adjusted, exemplary two-dimensional map of the workspace in some embodiments.

FIG. 4 illustrates an example of a user providing inputs on a user interface to customize a robotic floor-cleaning job in some embodiments.

FIGS. 5A and 5B illustrate an example of the process of adjusting boundary lines of a map in some embodiments.

FIG. 6 illustrates a flowchart of applications for customizing a floor cleaning job of a workspace in some embodiments.

FIG. 7 illustrates an example of a finite state machine chart in accordance with some embodiments.

FIG. 8 illustrates another example of a finite state machine chart in accordance with some embodiments.

FIG. 9 is a schematic diagram of an example of a robot with which the present techniques may be implemented in some embodiments.

FIG. 10 is a flowchart describing an example of a method for modifying a map and operational settings of a robot in different locations of the map in some embodiments.

### DETAILED DESCRIPTION OF CERTAIN EMBODIMENTS

The present techniques will now be described in detail with reference to a few embodiments thereof as illustrated in the accompanying drawings. In the following description, numerous specific details are set forth in order to provide a thorough understanding of the present inventions. It will be apparent, however, to one skilled in the art, that the present techniques may be practiced without some or all of these specific details. In other instances, well known process steps and/or structures have not been described in detail in order to not unnecessarily obscure the present inventions. Further, it should be emphasized that several inventive techniques are described, and embodiments are not limited to systems implementing all of those techniques, as various cost and engineering tradeoffs may warrant systems that only afford a subset of the benefits described herein or that will be apparent to one of ordinary skill in the art.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

The term “user interface” as used herein refers to an interface between a human user or operator and one or more devices that enables communication between the user and the device(s). Examples of user interfaces that may be employed in various implementations of the present inventions include, but are not limited to (which is not to suggest that any other description is limiting), switches, buttons, dials, sliders, a mouse, keyboard, keypad, game controllers, track balls, display screens, various types of graphical user interfaces (GUIs), touch screens, microphones, and other types of sensors that may receive some form of human-generated stimulus, including physical and verbal, and generate a signal in response thereto.

In some embodiments, a processor of a robotic device generates a map of a workspace. Simultaneous localization and mapping (SLAM) techniques, for example, may be used to create a map of a workspace and keep track of a robotic device's location within the workspace while obtaining data by which the map is formed or updated. Examples of methods for creating a map of an environment are described in U.S. patent application Ser. Nos. 16/048,179, 16/048,185, 16/163,541, 16/163,562, 16/163,508, 16/185,000, 62/681,965, 62/637,185, and 62/614,449, the entire contents of each of which are hereby incorporated by reference. In some embodiments, the processor (which may be a collection of processors, like a central processing unit and a computer-vision accelerating co-processor) of the robotic device localizes the robotic device during mapping and operation using methods such as those described in U.S. Patent Application Nos. 62/746,688, 62/740,753, 62/740,580, Ser. Nos. 15/614,284, 15/955,480, and 15/425,130, the entire contents of each of which are hereby incorporated by reference. In some embodiments, the processor of the robotic device marks doorways in the map of the environment (e.g., by noting the doorways in a data structure encoding the map in memory of the robot). Examples of methods for detecting doorways are described in U.S. patent application Ser. Nos. 16/163,541 and 15/614,284, the entire contents of each of which are hereby incorporated by reference. In some embodiments, the processor of the robotic device sends the map of the workspace to an application of a communication device. Examples of a communication device include, but are not limited to (which is not to suggest that other descriptions herein are limiting), a computer, a tablet, a smartphone, a laptop, or a dedicated remote control. In some embodiments, the map is accessed through the application of the communication device and displayed on a screen of the communication device, e.g., on a touchscreen. In some embodiments, the processor of the robotic device sends the map of the workspace to the application at various stages of completion of the map or after completion. In some embodiments, a client application on the communication device displays the map on the screen and receives a variety of inputs indication commands, using a user interface of the application (e.g., a native application) displayed on the screen of the communication device. Examples of graphical user interfaces are described in U.S. patent application Ser. Nos. 15/272,752 and 15/949,708, the entire contents of each of which are hereby incorporated by reference. Some embodiments present the map to the user in special-purpose software, a web application, or the like, in some cases in a corresponding user interface capable of receive commands to make adjustments to the map or adjust settings of the robotic device and its tools. In some embodiments, after selecting all or a portion of the boundary line, the user is provided by embodiments with various options, such as deleting, trimming, rotating, elongating, shortening, redrawing, moving (in four or more directions), flipping, or curving, the selected boundary line. In some embodiments, the user interface includes inputs by which the user adjusts or corrects the map boundaries displayed on the screen or applies one or more of the various options to the boundary line using their finger or by providing verbal instructions, or in some embodiments, an input device, such as a cursor, pointer, stylus, mouse, button or buttons, or other input methods may serve as a user-interface element by which input is received. In some embodiments, the user interface presents drawing tools available through the application of the communication device. In some embodiments, the application of the communication device sends the updated map to the processor of the robotic device using a wireless communication channel, such as Wi-Fi or Bluetooth.

In some embodiments, the map generated by the processor of the robotic device (or one or remote processors) contains errors, is incomplete, or does not reflect the areas of the workspace that the user wishes the robotic device to service. By providing an interface by which the user may adjust the map, some embodiments obtain additional or more accurate information about the robot's environment, thereby improving the robotic device's ability to navigate through the environment or otherwise operate in a way that better accords with the user's intent. For example, via such an interface, the user may extend the boundaries of the map in areas where the actual boundaries are further than those identified by sensors of the robotic device, trim boundaries where sensors identified boundaries further than the actual boundaries, or adjusts the location of doorways. Or the user may create virtual boundaries that segment a room for different treatment or across which the robot will not traverse. In some cases where the processor creates an accurate map of the workspace, the user may adjust the map boundaries to keep the robotic device from entering some areas.

In some embodiments, data is sent between the processor of the robotic device and the application of the communication device using one or more wireless communication channels such as Wi-Fi or Bluetooth wireless connections. In some cases, communications are relayed via a remote cloud-hosted application that mediates between the robot and the communication device, e.g., by exposing an application program interface by which the communication device accesses previous maps from the robot. In some embodiments, the processor of the robotic device and the application of the communication device are paired prior to sending data back and forth between one another. An example of a method for pairing a robotic device with a an application of a communication device is described in U.S. patent application Ser. No. 16/109,617, the entire contents of which is hereby incorporated by reference. In some cases, pairing may include exchanging a private key in a symmetric encryption protocol, and exchanges may be encrypted with the key.

In some embodiments, via the user interface (which may be a single screen, or a sequence of displays that unfold over time), the user creates different areas within the workspace. In some embodiments, the user selects areas within the map of the workspace displayed on the screen using their finger or providing verbal instructions, or in some embodiments, an input device, such as a cursor, pointer, stylus, mouse, button or buttons, or other input methods. Some embodiments may receive audio input, convert the audio to text with a speech-to-text model, and then map the text to recognized commands. In some embodiments, the user labels different areas of the workspace using the user interface of the application. In some embodiments, the user selects different settings, such as tool, cleaning and scheduling settings, for different areas of the workspace using the user interface. In some embodiments, the processor autonomously divides the workspace into different areas and in some instances, the user adjusts the areas of the workspace created by the processor using the user interface. Examples of methods for dividing a workspace into different areas and choosing settings for different areas are described in U.S. patent application Ser. Nos. 14/817,952, 16/198,393, 62/740,558, 62/590,205, 62/666,266, and 62/658,705, the entire contents of each of which are hereby incorporated by reference.

In some embodiments, the user adjusts or chooses tool settings of the robotic device using the user interface of the application of the communication device and designates areas in which the tool is to be applied with the adjustment. Examples of tools of the robotic device include a suction tool (e.g., a vacuum), a mopping tool (e.g., a mop), a sweeping tool (e.g., a rotating brush), a main brush tool, a side brush tool, and an ultraviolet (UV) light capable of killing bacteria. Tool settings that the user can adjust using the user interface may include activating or deactivating various tools, impeller motor speed for suction control, fluid release speed for mopping control, brush motor speed for vacuuming control, and sweeper motor speed for sweeping control. In some embodiments, the user chooses different tool settings for different areas within the workspace or schedules particular tool settings at specific times using the user interface. For example, the user selects activating the suction tool in only the kitchen and bathroom on Wednesdays at noon. In some embodiments, the user adjusts or chooses robot cleaning settings using the user interface. Robot cleaning settings include, but are not limited to, robot speed settings, movement pattern settings, cleaning frequency settings, cleaning schedule settings, etc. In some embodiments, the user chooses different robot cleaning settings for different areas within the workspace or schedules particular robot cleaning settings at specific times using the user interface. For example, the user chooses areas A and B of the workspace to be cleaned with the robot at high speed, in a boustrophedon pattern, on Wednesday at noon every week and areas C and D of the workspace to be cleaned with the robot at low speed, in a spiral pattern, on Monday and Friday at nine in the morning, every other week.

In addition to the robot cleaning settings of areas A, B, C, and D of the workspace the user selects tool settings using the user interface as well. In some embodiments, the user chooses the order of cleaning areas of the workspace using the user interface. In some embodiments, the user chooses areas to be excluded from cleaning using the user interface. In some embodiments, the user adjusts or creates a cleaning path of the robotic device using the user interface. For example, the user adds, deletes, trims, rotates, elongates, redraws, moves (in all four directions), flips, or curves a selected portion of the cleaning path. In some embodiments, the processor autonomously creates the cleaning path of the robotic device based on real-time sensory data using methods such as those described in U.S. patent application Ser. Nos. 16/041,286, 15/406,890, 16/163,530, 16/239,410, 62/735,137, and 14/673,633, the entire contents of which are hereby incorporated by reference. In some embodiments, the user adjusts the path created by the processor using the user interface. In some embodiments, the user chooses an area of the map using the user interface and applies particular tool and/or cleaning settings to the area. In other embodiments, the user chooses an area of the workspace from a drop-down list or some other method of displaying different areas of the workspace.

In some embodiments, the application of the communication device is paired with various different types of robotic devices and the graphical user interface of the application is used to instruct these various robotic devices. For example, the application of the communication device may be paired with a robotic chassis with a passenger pod and the user interface may be used to request a passenger pod for transportation from one location to another. In another example, the application of the communication device may be paired with a robotic refuse container and the user interface may be used to instruct the robotic refuse container to navigate to a refuse collection site or another location of interest. In one example, the application of the communication device may be paired with a robotic towing vehicle and the user interface may be used to request a towing of a vehicle from one location to another. In other examples, the user interface of the application of the communication device may be used to instruct a robotic device to carry and transport an item (e.g., groceries, signal boosting device, home assistant, cleaning supplies, luggage, packages being delivered, etc.), to order a pizza or goods and deliver them to a particular location, to request a defibrillator or first aid supplies to a particular location, to push or pull items (e.g., dog walking), to display a particular advertisement while navigating within a designated area of an environment, etc. Examples of various different types of robotic devices that are instructed using a graphical user interface of an application of a communication device paired with the robotic device are described in U.S. patent application Ser. Nos. 16/230,805, 16/129,757, 16/245,998, 16/243,524, 16/261,635, and 16/127,038, the entire contents of each of which are hereby incorporated by reference.

In some cases, user inputs via the user interface may be tested for validity before execution. Some embodiments may determine whether the command violates various rules, e.g., a rule that a mop and vacuum are not engaged concurrently. Some embodiments may determine whether adjustments to maps violate rules about well-formed areas, such as a rule specifying that areas are to be fully enclosed, a rule specifying that areas must have some minimum dimension, a rule specifying that an area must have less than some maximum dimension, and the like. Some embodiments may determine not to execute commands that violate such rules and vice versa.

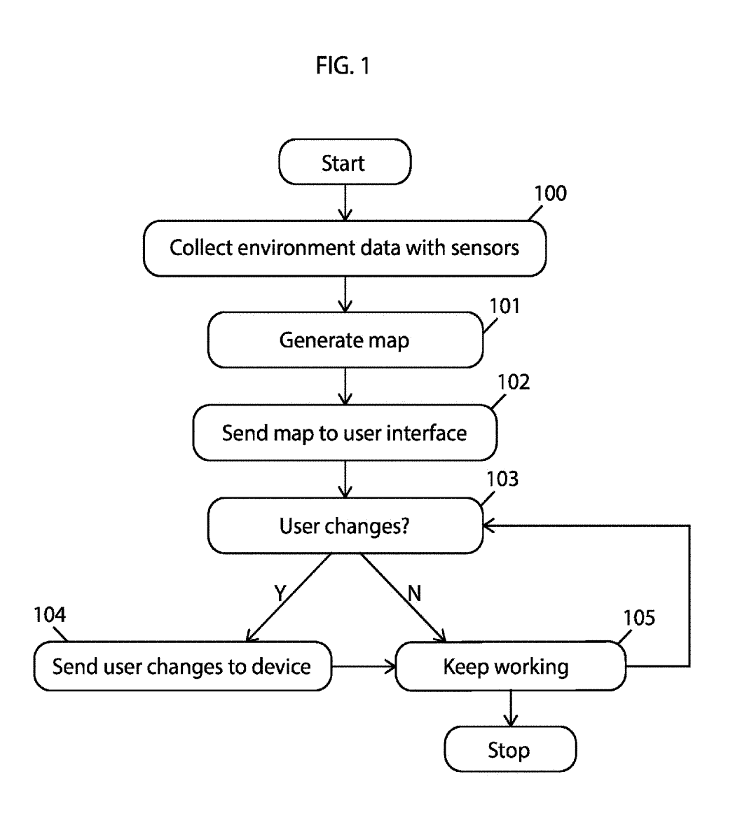

FIG. 1 illustrates an example of a process of creating and adjusting a two-dimensional map using an interactive user interface. In a first step 100, sensors positioned on a robotic device collect environmental data. In a next step 101, a processor of the robotic device generates a two-dimensional map of the workspace using the collected environmental data using a method such as those referenced above for creating a map of an environment, including those that use simultaneous localization and mapping (SLAM) techniques. In some methods, measurement systems, such as LIDAR, are used to measure distances from the robotic device to the nearest obstacle in a 360 degree plane in order to generate a two-dimensional map of the area. In a next step 102, the two-dimensional map is sent to an application of a communication device using one or more network communication connections and the map is displayed on the screen of the communication device such that a user can make adjustments or choose settings using a user interface of the application by, for example, a touchscreen or buttons or a cursor of the communication device. In a next step 103, the application of the communication device checks for changes made by a user using the user interface. If any changes are detected (to either the map boundaries or the operation settings), the method proceeds to step 104 to send the user changes to the processor of the robotic device. If no changes to the map boundaries or the operation settings are detected, the method proceeds to step 105 to continue working without any changes. These steps may be performed in the order provided or in another order and may include all steps or a select number of steps

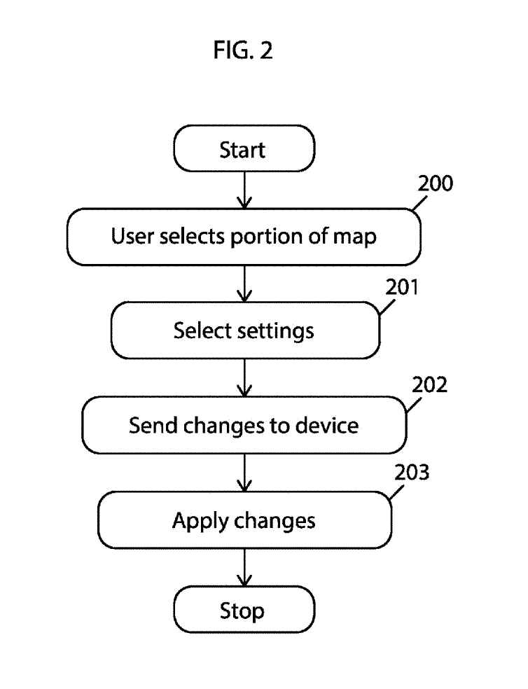

FIG. 2 illustrates the process of customizing robotic device operation using a user interface. In a first step 200, a user selects any size area (e.g., the selected area may be comprised of a small portion of the workspace or could encompass the entire workspace) of a workspace map displayed on a screen of a communication device using their finger, a verbal instruction, buttons, a cursor, or other input methods of the communication device. In a next step 201, the user selects desired settings for the selected area. The particular functions and settings available are dependent on the capabilities of the particular robotic device. For example, in some embodiments, a user can select any of: cleaning modes, frequency of cleaning, intensity of cleaning, navigation methods, driving speed, etc. In a next step 202, the selections made by the user are sent to a processor of the robotic device. In a next step 203, the processor of the robotic device processes the received data and applies the user changes. These steps may be performed in the order provided or in another order and may include all steps or a select number of steps.

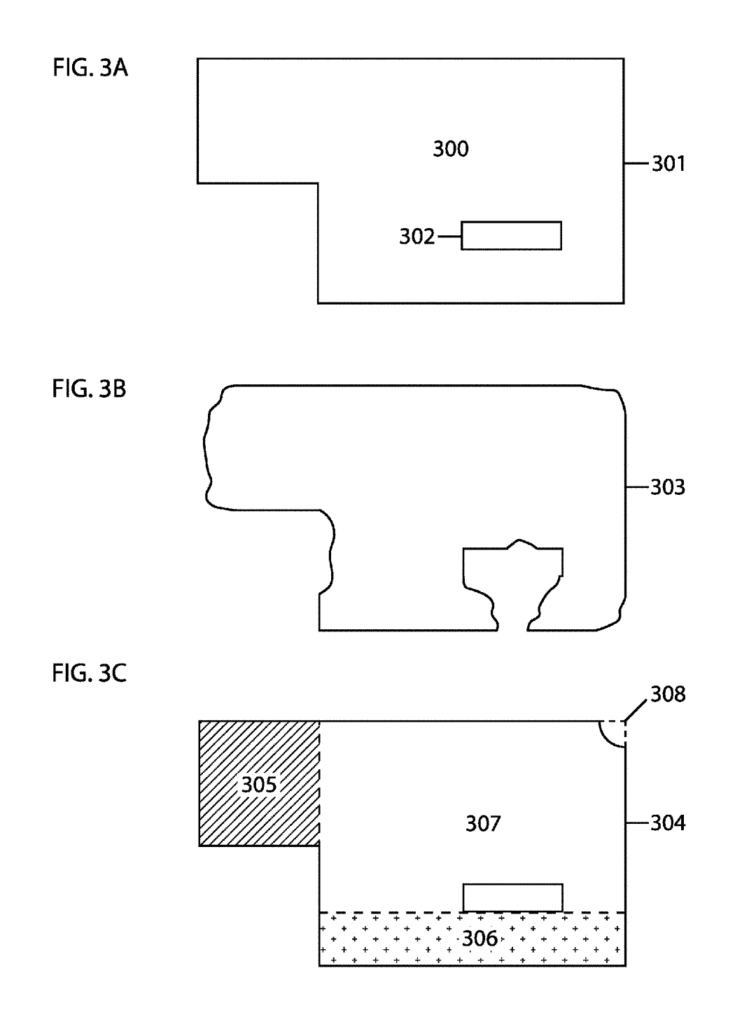

FIG. 3A illustrates an overhead view of a workspace 300. This view shows the actual obstacles of the workspace with outer line 301 representing the walls of the workspace 300 and the rectangle 302 representing a piece of furniture. FIG. 3B illustrates an overhead view of a two-dimensional map 303 of the workspace 300 created by a processor of the robotic device using environmental data collected by sensors. Because the methods for generating the map are not 100% accurate, the two-dimensional map 303 is approximate and thus performance of the robotic device may suffer as its navigation and operations within the environment are in reference to the map 303. To improve the accuracy of the map 303, a user may correct the boundary lines of the map to match the actual obstacles via a user interface of, for example, an application of a communication device. FIG. 3C illustrates an overhead view of a user-adjusted two-dimensional map 304. By changing the boundary lines of the map 303 (shown in FIG. 3B) created by the processor of the robotic device, a user is enabled to create a two-dimensional map 304 of the workspace 300 (shown in FIG. 3A) that accurately identifies obstacles and boundaries in the workspace. In this example, the user also creates areas 305, 306, and 307 within the two-dimensional map 304 and applies particular settings to them using the user interface. By delineating a portion 305 of the map 304, the user can select settings for area 305 independent from all other areas. For example, the user chooses area 305 and selects weekly cleaning, as opposed to daily or standard cleaning, for that area. In a like manner, the user selects area 306 and turns on a mopping function for that area. The remaining area 307 is treated in a default manner. Additional to adjusting the boundary lines of the two-dimensional map 304, the user can create boundaries anywhere, regardless of whether an actual boundary exists in the workspace. In the example shown, the boundary line in the corner 308 has been redrawn to exclude the area near the corner. The robotic device will thus avoid entering this area. This may be useful for keeping the robotic device out of certain areas, such as areas with fragile objects, pets, cables or wires, etc.

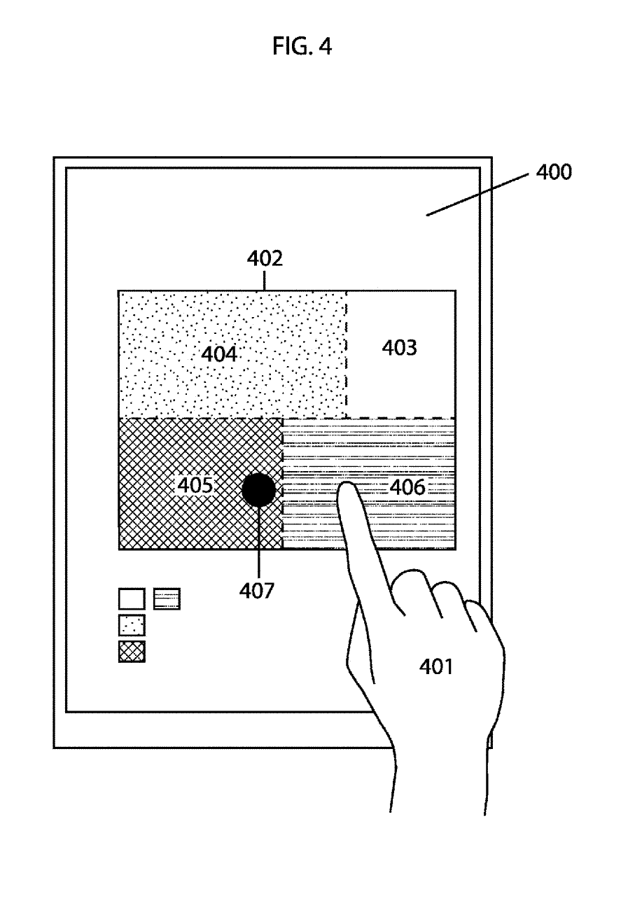

FIG. 4 illustrates an example of a user interface 400 of an application of a communication device 408. Examples of the communication device 408 include, but are not limited to, a mobile device, a tablet, a laptop, a remote, a specialized computer, or an integrated screen of a robotic device. A user 401 uses the user interface 400 to manipulate a map of the workspace 402 by delineating the map of workspace 402 into four sections: 403, 404, 405, and 406. The user uses the user interface 400 to further select different settings, such as cleaning mode settings, of the robotic device 407 for each section independently of the other sections. A processor of the robotic device 407 may receive the modified map and settings of the robotic device from the application of the communication device through a wireless connection. In this example, the user uses a finger to manipulate the map and input settings of the robotic device through a touchscreen; however, various other methods may be employed depending on the hardware of the device providing the user interface.

In some embodiments, setting a cleaning mode includes, for example, setting a service condition, a service type, a service parameter, a service schedule, or a service frequency for all or different areas of the workspace. A service condition indicates whether an area is to be serviced or not, and embodiments determine whether to service an area based on a specified service condition in memory. Thus, a regular service condition indicates that the area is to be serviced in accordance with service parameters like those described below. In contrast, a no service condition indicates that the area is to be excluded from service (e.g., cleaning). A service type indicates what kind of cleaning is to occur. For example, a hard (e.g. non-absorbent) surface may receive a mopping service (or vacuuming service followed by a mopping service in a service sequence), while a carpeted service may receive a vacuuming service. Other services can include a UV light application service, and a sweeping service. A service parameter may indicate various settings for the robotic device. In some embodiments, service parameters may include, but are not limited to, an impeller speed parameter, a wheel speed parameter, a brush speed parameter, a sweeper speed parameter, a liquid dispensing speed parameter, a driving speed parameter, a driving direction parameter, a movement pattern parameter, a cleaning intensity parameter, and a timer parameter. Any number of other parameters can be used without departing from embodiments disclosed herein, which is not to suggest that other descriptions are limiting. A service schedule indicates the day and, in some cases, the time to service an area, in some embodiments. For example, the robotic device may be set to service a particular area on Wednesday at noon. Examples further describing methods for setting a schedule of a robotic device are described in U.S. patent application Ser. Nos. 16/051,328 and 15/449,660, the entire contents of each of which are hereby incorporated by reference. In some instances, the schedule may be set to repeat. A service frequency indicates how often an area is to be serviced. In embodiments, service frequency parameters can include hourly frequency, daily frequency, weekly frequency, and default frequency. A service frequency parameter can be useful when an area is frequently used or, conversely, when an area is lightly used. By setting the frequency, more efficient overage of workspaces is achieved. In some embodiments, the robotic device cleans areas of the workspace according to the cleaning mode settings.

In some embodiments, the robotic device may navigate along a cleaning path (e.g., a coverage path) while cleaning areas of the workspace. In some embodiments, the processor of the robotic device determines a cleaning path in real-time based on observations of the environment while cleaning an area of the environment. An example of a method for generating a cleaning path in real-time based on observations of the environment is described in U.S. patent application Ser. Nos. 16/041,286, 16/163,530, 16/239,410, and 62/631,157, the entire contents of each of which are hereby incorporated by reference. In some embodiments, the processor of the robotic device determines its cleaning path based on debris accumulation within the environment. An example of a method for generating a cleaning path of a robotic device based on debris accumulation in an environment is described in U.S. patent application Ser. Nos. 16/163,530 and 16/239,410, the entire contents of which are hereby incorporated by reference. In some embodiments, the cleaning path is provided or modified by the user using the user interface.

In some embodiments, the processor of the robotic device determines or changes the cleaning mode settings based on collected sensor data. For example, the processor may change a service type of an area from mopping to vacuuming upon detecting carpeted flooring from sensor data (e.g., in response to detecting an increase in current draw by a motor driving wheels of the robot, or in response to a visual odometry sensor indicating a different flooring type). In a further example, the processor may change service condition of an area from no service to service after detecting accumulation of debris in the area above a threshold. Examples of methods for a processor to autonomously adjust settings (e.g., speed) of components of a robotic device (e.g., impeller motor, wheel motor, etc.) based on environmental characteristics (e.g., floor type, room type, debris accumulation, etc.) are described in U.S. patent application Ser. Nos. 16/163,530 and 16/239,410, the entire contents of each of which are hereby incorporated by reference. In some embodiments, the user adjusts the settings chosen by the processor using the user interface. In some embodiments, the processor changes the cleaning mode settings and/or cleaning path such that resources required for cleaning are not depleted during the cleaning session. In some instances, the processor uses a bin packing algorithm or an equivalent algorithm to maximize the area cleaned given the limited amount of resources remaining. In some embodiments, the processor analyzes sensor data of the environment before executing a service type to confirm environmental conditions are acceptable for the service type to be executed. For example, the processor analyzes floor sensor data to confirm floor type prior to providing a particular service type. In some instances, wherein the processor detects an issue in the settings chosen by the user, the processor sends a message that the user retrieves using the user interface. The message in other instances may be related to cleaning or the map. For example, the message may indicate that an area with no service condition has high (e.g., measured as being above a predetermined or dynamically determined threshold) debris accumulation and should therefore have service or that an area with a mopping service type was found to be carpeted and therefore mopping was not performed. In some embodiments, the user overrides a warning message prior to the robotic device executing an action.

In some embodiments, conditional cleaning mode settings may be set using a user interface and are provided to the processor of the robotic floor-cleaning device using a wireless communication channel. Upon detecting a condition being met, the processor implements particular cleaning mode settings (e.g., increasing impeller motor speed upon detecting dust accumulation beyond a specified threshold or activating mopping upon detecting a lack of motion). In some embodiments, conditional cleaning mode settings are preset or chosen autonomously by the processor of the robotic device.

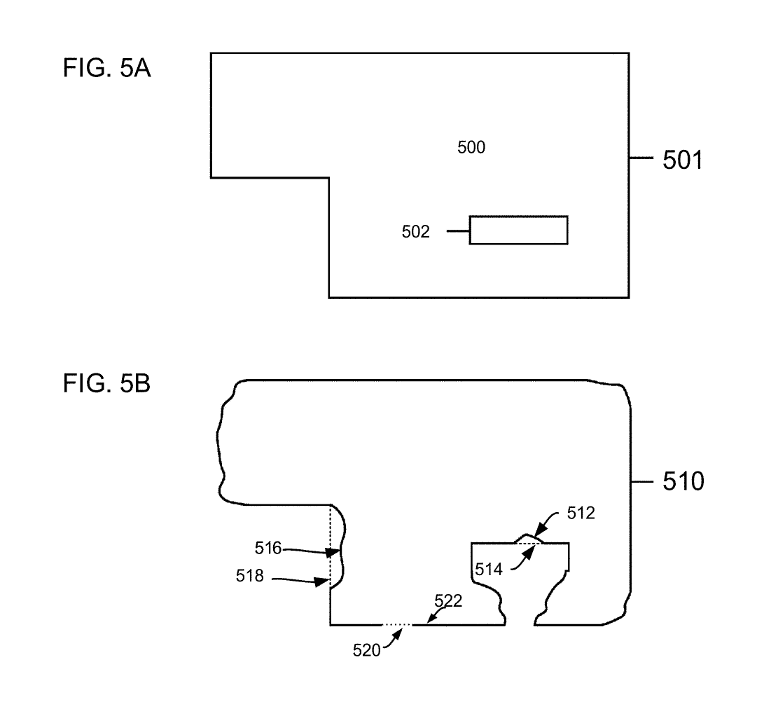

FIGS. 5A and 5B illustrate an example of changing boundary lines of a map based on user inputs via a graphical user interface, like on a touchscreen. FIG. 5A depicts an overhead view of a workspace 500. This view shows the actual obstacles of workspace 500. The outer line 501 represents the walls of the workspace 500 and the rectangle 502 represents a piece of furniture. Commercial use cases are expected to be substantially more complex, e.g., with more than 2, 5, or 10 obstacles, in some cases that vary in position over time. FIG. 5B illustrates an overhead view of a two-dimensional map 510 of the workspace 500 created by a processor of a robotic device using environmental sensor data. Because the methods for generating the map are often not 100% accurate, the two-dimensional map 510 may be approximate. In some instances, performance of the robotic device may suffer as a result of imperfections in the generated map 510. In some embodiments, a user corrects the boundary lines of map 510 to match the actual obstacles and boundaries of workspace 500.

In some embodiments, the user is presented with a user interface displaying the map 510 of the workspace 500 on which the user may add, delete, and/or otherwise adjust boundary lines of the map 510. For example, the processor of the robotic device may send the map 510 to an application of a communication device wherein user input indicating adjustments to the map are received through a user interface of the application. The input triggers an event handler that launches a routine by which a boundary line of the map is added, deleted, and/or otherwise adjusted in response to the user input, and an updated version of the map may be stored in memory before being transmitted back to the processor of the robotic device.

For instance, in map 510, the user manually corrects boundary line 516 by drawing line 518 and deleting boundary line 516 in the user interface. In some cases, user input to add a line may specify endpoints of the added line or a single point and a slope. Some embodiments may modify the line specified by inputs to “snap” to likely intended locations. For instance, inputs of line endpoints may be adjusted by the processor to equal a closest existing line of the map. Or a line specified by a slope and point may have endpoints added by determining a closest intersection relative to the point of the line with the existing map. In some cases, the user may also manually indicate with portion of the map to remove in place of the added line, e.g., separately specifying line 518 and designating curvilinear segment 516 for removal. Or some embodiments may programmatically select segment 516 for removal in response to the user inputs designating line 518, e.g., in response to determining that areas 516 and 518 bound an areas of less than a threshold size, or by determining that line 516 is bounded on both sides by areas of the map designated as part of the workspace.

In some embodiments, the application suggests a correcting boundary. For example, embodiments may determine a best-fit polygon of a boundary of the (as measured) map through a brute force search or some embodiments may suggest a correcting boundary with a Hough Transform, the Ramer-Douglas-Peucker algorithm, the Visvalingam algorithm, or other line-simplification algorithm. Some embodiments may determine candidate suggestions that do not replace an extant line but rather connect extant segments that are currently unconnected, e.g., some embodiments may execute a pairwise comparison of distances between endpoints of extant line segments and suggest connecting those having distances less than a threshold distance apart. Some embodiments may select, from a set of candidate line simplifications, those with a length above a threshold or those with above a threshold ranking according to line length for presentation.

In some embodiments, presented candidates may be associated with event handlers in the user interface that cause the selected candidates to be applied to the map. In some cases, such candidates may be associated in memory with the line segments they simplify, and the associated line segments that are simplified may be automatically removed responsive to the event handler receive a touch input event corresponding to the candidate.

For instance, in map 510, in some embodiments, the application suggests correcting boundary line 512 by displaying suggested correction 514. The user accepts the corrected boundary line 514 that will replace and delete boundary line 512 by supplying inputs to the user interface. In some cases, where boundary lines are incomplete or contain gaps, the application suggests their completion. For example, the application suggests closing the gap 520 in boundary line 522. Suggestions may be determined by the robot, the application executing on the communication device, or other services, like a cloud-based service or computing device in a base station.

Boundary lines can be edited in a variety of ways such as, for example, adding, deleting, trimming, rotating, elongating, redrawing, moving (e.g., upward, downward, leftward, or rightward), suggesting a correction, and suggesting a completion to all or part of the boundary line. In some embodiments, the application suggests an addition, deletion or modification of a boundary line and in other embodiments the user manually adjusts boundary lines by, for example, elongating, shortening, curving, trimming, rotating, translating, flipping, etc. the boundary line selected with their finger or buttons or a cursor of the communication device or by other input methods. In some embodiments, the user deletes all or a portion of the boundary line and redraws all or a portion of the boundary line using drawing tools, e.g., a straight-line drawing tool, a Bezier tool, a freehand drawing tool, and the like. In some embodiments, the user adds boundary lines by drawing new boundary lines. In some embodiments, the application identifies unlikely boundaries created (newly added or by modification of a previous boundary) by the user using the user interface. In some embodiments, the application identifies one or more unlikely boundary segments by detecting one or more boundary segments oriented at an unusual angle (e.g., less than 25 degrees relative to a neighboring segment or some other threshold) or one or more boundary segments comprising an unlikely contour of a perimeter (e.g., short boundary segments connected in a zig-zag form). In some embodiments, the application identifies an unlikely boundary segment by determining the surface area enclosed by three or more connected boundary segments, one being the newly created boundary segment and identifies the boundary segment as an unlikely boundary segment if the surface area is less than a predetermined (or dynamically determined) threshold. In some embodiments, other methods are used in identifying unlikely boundary segments within the map. In some embodiments, the user interface may present a warning message using the user interface, indicating that a boundary segment is likely incorrect. In some embodiments, the user ignores the warning message or responds by correcting the boundary segment using the user interface.

In some embodiments, the application autonomously suggests a correction to boundary lines by, for example, identifying a deviation in a straight boundary line and suggesting a line that best fits with regions of the boundary line on either side of the deviation (e.g. by fitting a line to the regions of boundary line on either side of the deviation). In other embodiments, the application suggests a correction to boundary lines by, for example, identifying a gap in a boundary line and suggesting a line that best fits with regions of the boundary line on either side of the gap. In some embodiments, the application identifies an end point of a line and the next nearest end point of a line and suggests connecting them to complete a boundary line. In some embodiments, the application only suggests connecting two end points of two different lines when the distance between the two is below a particular threshold distance. In some embodiments, the application suggests correcting a boundary line by rotating or translating a portion of the boundary line that has been identified as deviating such that the adjusted portion of the boundary line is adjacent and in line with portions of the boundary line on either side. For example, a portion of a boundary line is moved upwards or downward or rotated such that it is in line with the portions of the boundary line on either side. In some embodiments, the user may manually accept suggestions provided by the application using the user interface by, for example, touching the screen, pressing a button or clicking a cursor. In some embodiments, the application may automatically make some or all of the suggested changes.

In some embodiments, maps are represented in vector graphic form or with unit tiles, like in a bitmap. In some cases, changes may take the form of designating unit tiles via a user interface to add to the map or remove from the map. In some embodiments, bitmap representations may be modified (or candidate changes may be determined) with, for example, a two-dimensional convolution configured to smooth edges of mapped workspace areas (e.g., by applying a Gaussian convolution to a bitmap with tiles having values of 1 where the workspace is present and 0 where the workspace is absent and suggesting adding unit tiles with a resulting score above a threshold). In some cases, the bitmap may be rotated to align the coordinate system with walls of a generally rectangular room, e.g., to an angle at which a diagonal edge segments are at an aggregate minimum. Some embodiments may then apply a similar one-dimensional convolution and thresholding along the directions of axes of the tiling, but applying a longer stride than the two-dimensional convolution to suggest completing likely remaining wall segments.

Reference to operations performed on “a map” may include operations performed on various representations of the map. For instance, a robot may store in memory a relatively high-resolution representation of a map, and a lower-resolution representation of the map may be sent to a communication device for editing. In this scenario, the edits are still to “the map,” notwithstanding changes in format, resolution, or encoding. Similarly, a map stored in memory of a robot, while only a portion of the map may be sent to the communication device, and edits to that portion of the map are still properly understood as being edits to “the map” and obtaining that portion is properly understood as obtaining “the map.” Maps may be said to be obtained from a robot regardless of whether the maps are obtained via direct wireless connection between the robot and a communication device or obtained indirectly via a cloud service. Similarly, a modified map may be said to have been sent to the robot even if only a portion of the modified map, like a delta from a previous version currently stored on the robot, it sent.

In some embodiments, the user interface may present a map, e.g., on a touchscreen, and areas of the map (e.g., corresponding to rooms or other sub-divisions of the workspace, e.g., collections of contiguous unit tiles in a bitmap representation) in pixel-space of the display may be mapped to event handlers that launch various routines responsive to events like an on-touch event, a touch release event, or the like. In some cases, before or after receiving such a touch event, the user interface may present the user with a set of user-interface elements by which the user may instruct embodiments to apply various commands to the area. Or in some cases, the areas of a working environment are depicted in the user interface without also depicting their spatial properties, e.g., as a grid of options without conveying their relative size or position.

Examples of commands specified via the user interface include assigning an operating mode to an area, e.g., a cleaning mode or a mowing mode. Modes may take various forms. Examples include modes that specify how a robot performs a function, like modes that select which tools to apply and settings of those tools. Other examples include modes that specify target results, e.g., a “heavy clean” mode versus a “light clean” mode, a quite vs loud mode, or a slow versus fast mode. In some cases, such modes may be further associated with scheduled times in which operation subject to the mode is to be performed in the associated area. In some embodiments, a given area may be designated with multiple modes, e.g., a vacuuming mode and a quite mode. In some cases, modes are nominal properties, ordinal properties, or cardinal properties, e.g., a vacuuming mode, a heaviest-clean mode, a 10/seconds/linear-foot vacuuming mode, respectively.

Examples of commands specified via the user interface include commands that schedule when modes of operations are to be applied to areas. Such scheduling may include scheduling when cleaning is to occur or when cleaning using a designed mode is to occur. Scheduling may include designating a frequency, phase, and duty cycle of cleaning, e.g., weekly, on Monday at 4, for 45 minutes. Scheduling, in some cases, may include specifying conditional scheduling, e.g., specifying criteria upon which modes of operation are to be applied. Examples include events in which no motion is detected by a motion sensor of the robot or a base station for more than a threshold duration of time, or events in which a third-party API (that is polled or that pushes out events) indicates certain weather events have occurred, like rain. In some cases, the user interface exposes inputs by which such criteria may be composed by the user, e.g., with Boolean connectors, for instance “If no-motion-for-45-minutes, and raining, then apply vacuum mode in area labeled “kitchen.”

In some embodiments, the user interface may display information about a current state of the robot or previous states of the robot or its environment. Examples include a heat map of dirt or debris sensed over an area, visual indications of classifications of floor surfaces in different areas of the map, visual indications of a path that the robot has taken during a current cleaning session or other type of work session, visual indications of a path that the robot is currently following and has computed to plan further movement in the future, and visual indications of a path that the robot has taken between two points in the workspace, like between a point A and a point B on different sides of a room or a house in a point-to-point traversal mode. In some embodiments, while or after a robot attains these various states, the robot may report information about the states to the application via a wireless network, and the application may update the user interface on the communication device to display the updated information.

For example, in some cases, the robot may report which areas of the working environment have been covered during a current working session, for instance, in a stream of data to the application executing on the communication device formed via a WebRTC Data connection, or with periodic polling by the application, and the application executing on the computing device may update the user interface to depict which areas of the working environment have been covered. In some cases, this may include depicting a line of a path traced by the robot or adjusting a visual attribute of areas or portions of areas that have been covered, like color or shade or areas or boundaries. In some embodiments, the visual attributes may be varied based upon attributes of the environment sensed by the robot, like an amount of dirt or a classification of a flooring type since by the robot. In some embodiments, a visual odometer implemented with a downward facing camera may capture images of the floor, and those images of the floor, or a segment thereof, may be transmitted to the application to apply as a texture in the visual representation of the working environment in the map, for instance, with a map depicting the appropriate color of carpet, wood floor texture, tile, or the like to scale in the different areas of the working environment.

In some embodiments, the user interface may indicate in the map a path the robot is about to take (e.g., according to a routing algorithm) between two points, to cover an area, or to perform some other task. For example, a route may be depicted as a set of line segments or curves overlaid on the map, and some embodiments may indicate a current location of the robot with an icon overlaid on one of the line segments with an animated sequence that depicts the robot moving along the line segments.

In some embodiments, the future movements of the robot or other activities of the robot may be depicted in the user interface. For example, the user interface may indicate which room or other area the robot is currently covering and which room or other area the robot is going to cover next in a current work sequence. The state of such areas may be indicated with a distinct visual attribute of the area, its text label, or its boundary, like color, shade, blinking outlines, and the like. In some embodiments, a sequence with which the robot is currently programmed to cover various areas may be visually indicated with a continuum of such visual attributes, for instance, ranging across the spectrum from red to blue (or dark grey to light) indicating sequence with which subsequent areas are to be covered.

In some embodiments, via the user interface or automatically without user input, a starting and an ending point for a path to be traversed by the robot may be indicated on the user interface of the application executing on the communication device. Some embodiments may depict these points and propose various routes therebetween, for example, with various routing algorithms like those described in the applications incorporated by reference herein. Examples include A*, Dijkstra's algorithm, and the like. In some embodiments, a plurality of alternate candidate routes may be displayed (and various metrics thereof, like travel time or distance), and the user interface may include inputs (like event handlers mapped to regions of pixels) by which a user may select among these candidate routes by touching or otherwise selecting a segment of one of the candidate routes, which may cause the application to send instructions to the robot that cause the robot to traverse the selected candidate route.

In some embodiments, the map formed by the robot during traversal of the working environment may have various artifacts like those described herein. Using techniques like the line simplification algorithms and convolution will smoothing and filtering, some embodiments may remove clutter from the map, like artifacts from reflections or small objects like chair legs to simplify the map, or a version thereof in lower resolution to be depicted on a user interface of the application executed by the communication device. In some cases, this may include removing duplicate borders, for instance, by detecting border segments surrounded on two sides by areas of the working environment and removing those segments.

Some embodiments may rotate and scale the map for display in the user interface. In some embodiments, the map may be scaled based on a window size such that a largest dimension of the map in a given horizontal or vertical direction is less than a largest dimension in pixel space of the window size of the communication device or a window thereof in which the user interfaces displayed. Or in some embodiments, the map may be scaled to a minimum or maximum size, e.g., in terms of a ratio of meters of physical space to pixels in display space. Some embodiments may include zoom and panning inputs in the user interface by which a user may zoom the map in and out, adjusting scaling, and pan to shifts which portion of the map is displayed in the user interface.

In some embodiments, rotation of the map or portions thereof (like boundary lines) may be determined with techniques like those described above by which an orientation that minimizes an amount of aliasing, or diagonal lines of pixels on borders, is minimized. Or borders may be stretched or rotated to connect endpoints determined to be within a threshold distance. In some embodiments, an optimal orientation may be determined over a range of candidate rotations that is constrained to place a longest dimension of the map aligned with a longest dimension of the window of the application in the communication device. Or in some embodiments, the application may query a compass of the communication device to determine an orientation of the communication device relative to magnetic north and orient the map in the user interface such that magnetic north on the map as displayed is aligned with magnetic north as sensed by the communication device. In some embodiments, the robot may include a compass and annotate locations on the map according to which direction is magnetic north.

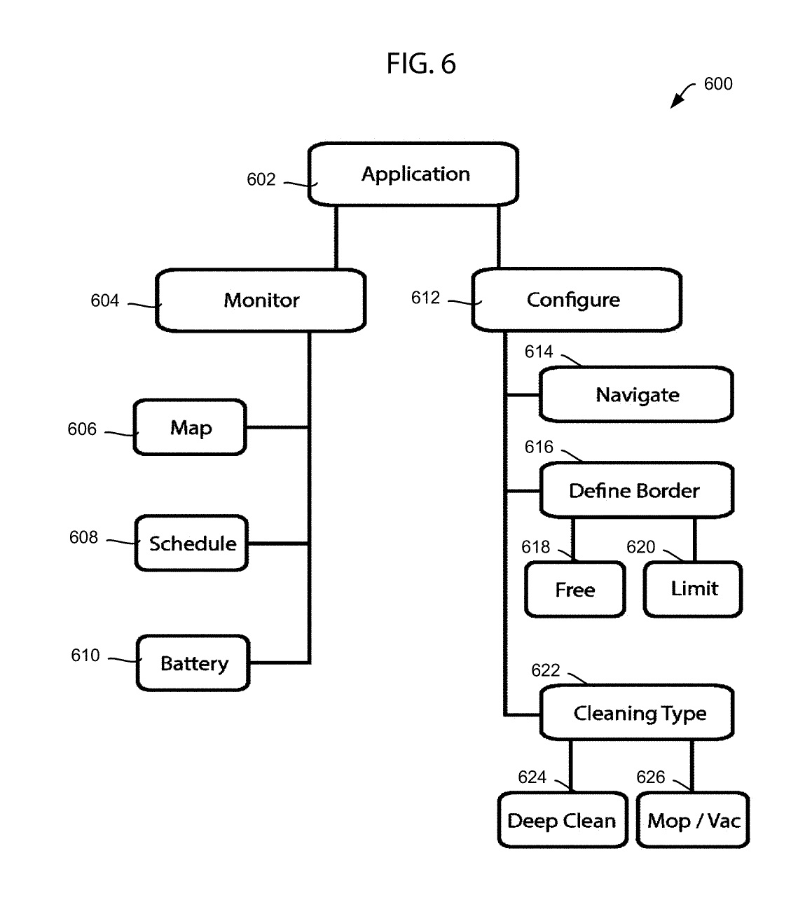

FIG. 6 illustrates an example of a logical architecture block diagram 600 of applications 602 for customizing a floor cleaning job of a workspace. Applications 602 include at least two subdivisions: monitoring 604 and configuring 612. In some embodiments, applications are executed by a processor of a robotic device, a processor of a communication device (e.g., mobile device, laptop, tablet, specialized computer), a processor of a base station of a robotic device, or by other devices. In some embodiments, applications are executed on the cloud and in other embodiments applications are executed locally on a device. In some embodiments, different applications are executed by different means. In some embodiments, applications are autonomously executed by, for example, a processor and in other embodiments, a user provides instructions to the processor using a user interface of a mobile application, software, or web application of a communication device or user interface of a hardware device that has wireless communication with the processor of the robotic device.

In monitoring 604, applications include mapping functions 606, scheduling functions 608, and battery status functions 610. Mapping functions may correspond with generating a map (which may include updating an extant map) of a workspace based on the workspace environmental data and displaying the map on a user interface. Scheduling functions may include setting operation times (e.g., date and time) and frequency with, for example, a timer. In embodiments, service frequency indicates how often an area is to be serviced. In embodiments, operation frequency may include hourly, daily, weekly, and default frequencies. Some embodiments select a frequency responsive to a time-integrate of a measure of detected movement from a motion sensor, e.g., queried via a home automation API or in a robot or base station. Other embodiments select a frequency based on ambient weather conditions accessed via the Internet, e.g., increasing frequency responsive to rain or dusty conditions. Some embodiments select a frequency autonomously based on sensor data of the environment indicative of, for example, debris accumulation, floor type, use of an area, etc.

In configuring 612, applications may include navigating functions 614, defining border or boundary functions 616, and cleaning mode functions 622. Navigating functions may include selecting a navigation mode for an area such as selecting a default navigation mode, selecting a user pattern navigation mode, and selecting an ordered coverage navigation mode. A default navigation mode may include methods used by a robotic floor-cleaning device in the absence of user-specified changes. A user pattern navigation mode may include setting any number of waypoints and then ordering coverage of an area that corresponds with the waypoints. An ordered coverage navigation mode may include selecting an order of areas to be covered—each area having a specified navigation mode. Defining borders or boundary functions may allow users to freely make changes (618) to boundaries such as those disclosed above. In addition, users may limit (620) robotic devices by, for example, creating exclusion areas. Cleaning mode functions may include selecting an intensity of cleaning such as deep cleaning 624 and a type of cleaning such as mopping or vacuuming 626.

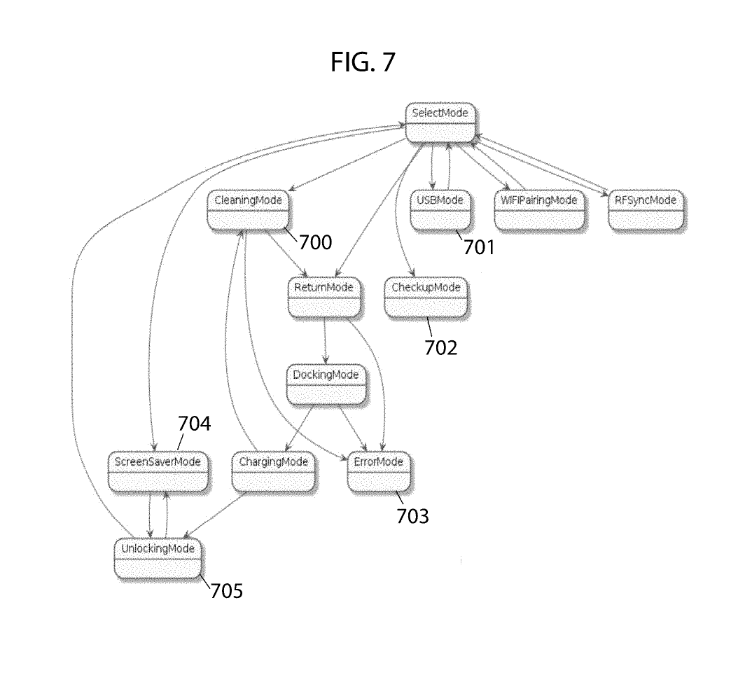

In some embodiments, the robotic device contains several different modes. These modes may include a function selection mode, a screen saving mode, an unlocking mode, a locking mode, a cleaning mode, a mopping mode, a return mode, a docking mode, an error mode, a charging mode, a Wi-Fi pairing mode, a Bluetooth pairing mode, an RF sync mode, a USB mode, a checkup mode, and the like. In some embodiments, the processor (in virtue of executing the application) may represent these modes using a finite state machine (FSM) made up of a set of states, each state representing a different mode, an initial state, and conditions for each possible transition from one state to another. The FSM can be in exactly one of a finite number of states at any given time. The FSM can transition from one state to another in response to observation of a particular event, observation of the environment, completion of a task, user input, and the like. FIG. 7 illustrates an example of a simplified FSM chart, where different modes are shown, such as cleaning mode 700, USB mode 701, checkup mode 702, and error mode 703. Possible transitions between states (for some embodiments) are represented by directed arrows. For example, from screensaver mode 704, a transition to unlocking mode 705 and vice versa is possible.

In some embodiments, a graphical user interface (GUI) of an electronic (or communication) device may be used to control the robotic device. Electronic devices may include a smartphone, computer, tablet, dedicated remote control, or other similar device that is capable of displaying output data from the robotic device and receiving inputs from a user. In some embodiments, the GUI is provided by a mobile device application loaded onto a mobile electronic device. In some embodiments, prior to using the mobile device application the mobile device is paired with the robotic device using a Wi-Fi connection. Wi-Fi pairing allows all user inputs into the mobile device application to be wirelessly shared with the robotic device, allowing the user to control the robotic device's functionality and operation. In some embodiments, inputs into the mobile device application are transferred to the cloud and retrieved from the cloud by the robotic device. The robotic device may also transfer information to the cloud, which may then be retrieved by the mobile device application.

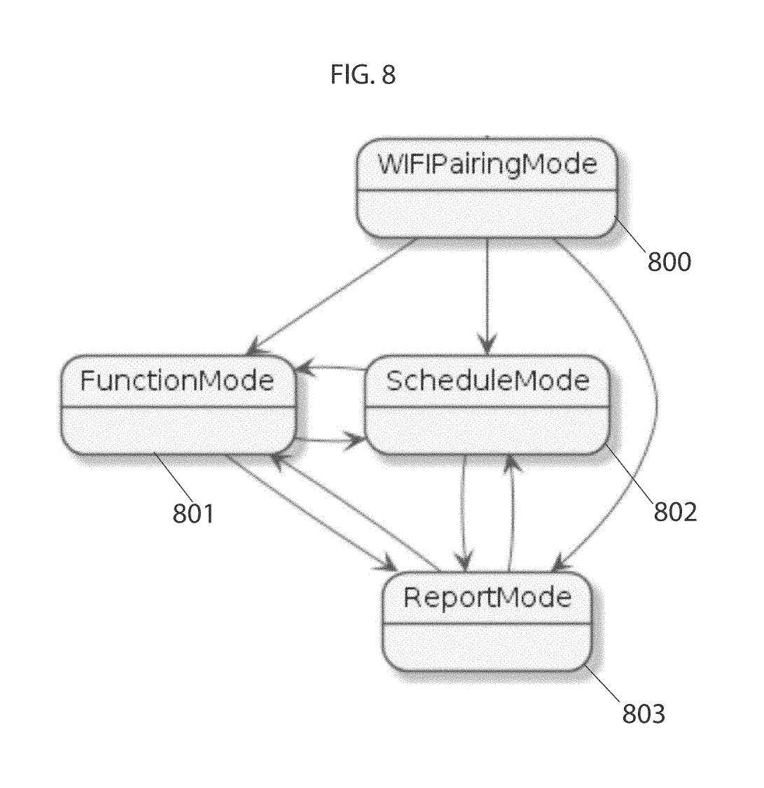

An example of a method for wirelessly pairing a mobile device with a robotic device is described in U.S. patent application Ser. Nos. 16/109,617 and 62/667,977, the entire contents of each of which are hereby incorporated by reference. In some embodiments, the mobile device application contains a FSM such that the user may switch between different modes that are used in controlling the robotic device. In some embodiments, different modes are accessible from a drop-down list, or similar menu option, within the mobile device application from which the user can select the mode. FIG. 8 illustrates an example of a FSM chart for a mobile device application. Once the mobile device has completed Wi-Fi pairing mode 800, function mode 801, schedule mode 802, and report mode 803 are accessible and transition between any of these three states is possible as indicated by the directed arrows. In some embodiments, function mode is used to select function(s) of the robotic device, such as vacuuming, mopping, sweeping, sanitizing, recharging, and the like. In some embodiments, the user selects various operation modes for the robotic device, such as quiet mode, low power mode, partial or full vacuuming speed mode, partial or full brush speed mode, partial or full driving speed and limits the robotic device's ability to operate on particular surface types and avoid certain obstacles, such as dynamic obstacles and the like. These selection options are not intended to be an exhaustive list. In some embodiments, the user uses schedule mode to set the schedule of operations such as day and time, type of operation, location, and the like. For example, the user can set vacuuming on Tuesdays at 9:00 am in the bedrooms and mopping on Fridays at 6:00 pm in the kitchen.

In some embodiments, report mode is used to report notifications such as errors or task completion and/or to access cleaning statistics of the robotic device. Diagnostic information can also be reported, such as low battery levels, required part replacements and the like. In some embodiments, checkup mode is included in the FSM and is used to check functionality of key components such as touch keys, wheels, IR sensors, bumper, etc. In some embodiments, based on notifications, errors and/or warnings reported in report mode, the user chooses specific diagnostic tests when in checkup mode to particularly target issues of the robotic device. In some embodiments, a processor of the robotic device determines the proper diagnostic test and performs the diagnostic test itself In some embodiments, the processor disables all modes when in checkup mode until the processor completes all diagnostic tests and reboots. In another embodiment, RF sync mode is included in the FSM. When in RF sync mode, the robotic device and corresponding charging station and/or virtual wall block sync with one another via RF. RF transmitters and receivers of RF modules are set at the same RF channel for communication. In some embodiments, the processor produces an alarm, such as a buzz, a vibration, or illumination of an LED when pairing with the charging station or when the virtual wall block is complete. Other indicators may also be used. The modes discussed herein are not intended to represent an exhaustive list of possible modes but are presented for exemplary purposes. Any other types of modes, such as USB mode, docking mode and screen saver mode, may be included in the FSM of the mobile device application.

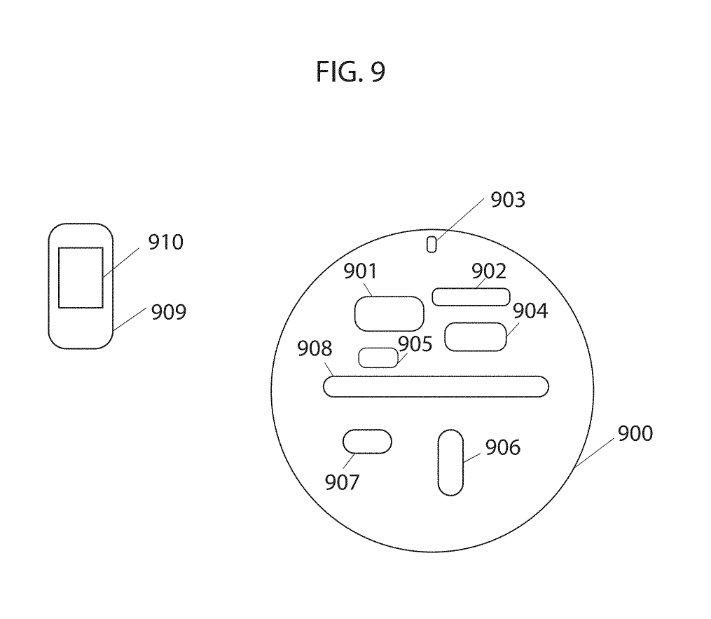

FIG. 9 depicts an example of a robotic device 900 with processor 901, memory 902, a first set of sensors 903, second set of sensors 904, network communication 905, movement driver 906, timer 907, more or more cleaning tools 908, and base station 911. The first and second set of sensors 903 and 904 may include depth measuring devices, movement measuring devices, and the like. In some embodiments, the robotic device may include the features (and be capable of the functionality) of a robotic device described herein. In some embodiments, program code stored in the memory 902 and executed by the processor 901 may effectuate the operations described herein. Some embodiments additionally include user device 909 having a touchscreen 910 and that executes a native application by which the user interfaces with the robot as described herein. While many of the computational acts herein are described as being performed by the robot, it should be emphasized that embodiments are also consistent with use cases in which some or all of these computations are offloaded to a base station computing device on a local area network with which the robot communicates via a wireless local area network or a remote data center accessed via such networks and the public internet.

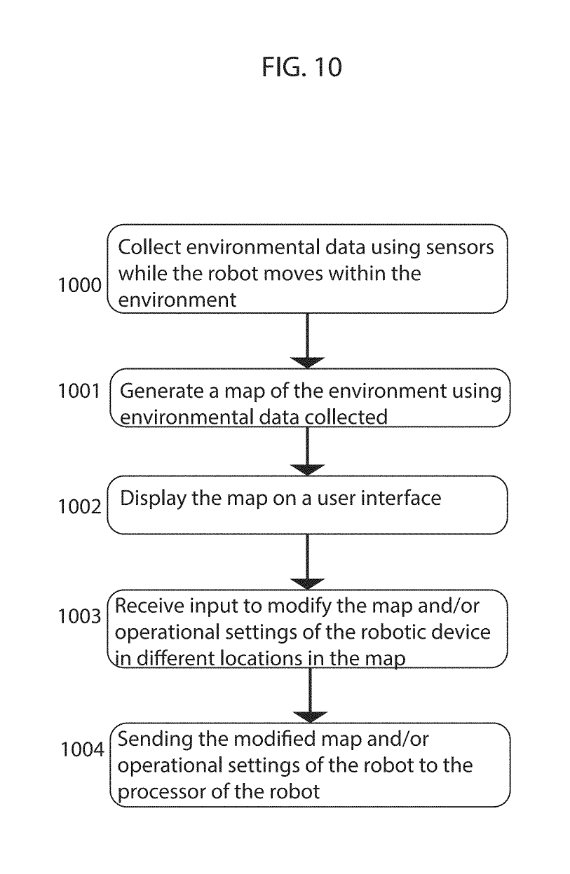

FIG. 10 illustrates a flowchart describing embodiments of a path planning method of a robotic device 1000, 1001, 1002, 1003 and 1004 corresponding with steps performed in some embodiments. The steps provided may be performed in the order listed or in a different order and may include all steps or only a select number of steps.

In some embodiments, map data is encrypted when uploaded to the cloud, with an on-device only encryption key to protect customer privacy. For example, a unique ID embedded in the MCU of the robotic device is used as a decryption key of the encrypted map data when uploading to the cloud. The unique ID of the MCU is not recorded or tracked at production, which prevents floor maps from being viewed or decrypted expect by the user, thereby protecting user privacy. When the robotic device requests the map from the cloud, the cloud sends the encrypted map data and the robotic device is able to decrypt the data from the cloud using the unique ID. In some embodiments, users may choose to share their map. In such cases, data will be anonymized.

In some embodiments, a real-time robotic device manager is accessible using a user interface to allow a user to instruct the real-time operation of the robotic device regardless of the device's location within the two-dimensional map. Instructions may include any of turning on or off a mop tool, turning on or off a UV light tool, turning on or off a suction tool, turning on or off an automatic shutoff timer, increasing speed, decreasing speed, driving to a user-identified location, turning in a left or right direction, driving forward, driving backward, stopping movement, commencing one or a series of movement patterns, or any other preprogrammed action.

Various embodiments are described herein below, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a specialized computer and/or a dedicated computing device when appropriately programmed and may include a combination of a computer/computing device and dedicated/programmable circuits adapted for the various tasks pertaining to embodiments of the inventions.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted; for example, such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation.

The present techniques will be better understood with reference to the following enumerated embodiments:
1. A tangible, non-transitory, machine-readable medium storing instructions that when executed by one or more processors effectuate operations comprising: obtaining, with an application executed by a communication device, from a robot that is physically separate from the communication device, a map of a working environment of the robot, the map being based on data sensed by the robot while traversing the working environment; presenting, with the application executed by the communication device, a user interface having inputs by which, responsive to user inputs, modes of operation of the robot are assigned to areas of the working environment depicted in the user interface; receiving, with the application executed by the communication device, a first set of one or more inputs via the user interface, wherein the first set of one or more inputs: designate a first area of the working environment, and designate a first mode of operation of the robot to be applied in the designated first area of the working environment; and after receiving the first set of one or more inputs, causing, with the application executed by the communication device, the robot to be instructed to apply the first mode of operation in the first area of the working environment.
2. The medium of embodiment 1, wherein the operations comprise: receiving, with the application executed by the communication device, a second set of one or more inputs via the user interface, wherein the second set of one or more inputs: designate a second area of the working environment, the second area being different from the first area, and designate a second mode of operation of the robot to be applied in the designated first area of the working environment, the second mode of operation being different from the first mode of operation; after receiving the second set of one or more inputs, causing, with the application executed by the communication device, the robot to be instructed to apply the second mode of operation in the second area of the working environment, the second mode of operation being applied during a work session of the robot in which the first mode of operation is also applied in the first area of the working environment.
3. The medium of embodiment 1, wherein: the user interface has inputs by which application of modes of operation to areas of the working environment are scheduled; and the operations comprise: receiving, via the user interface, in the first set of one or more inputs, or in another set of one or more inputs, an input indicating when the first mode of operation is to be applied in the first area; and causing, with the application executed by the communication device, the robot to be instructed to apply the first mode of operation in the first area of the working environment according to the input indicating when the first mode of operation is to be applied in the first area of the working environment.
4. The medium of embodiment 1, wherein the operations comprise: receiving, with the application executed by the communication device, a second set of one or more inputs via the user interface, wherein the second set of one or more inputs: designate a second area of the working environment, the second area being different from the first area, and designate a second mode of operation of the robot to be applied in the second area of the working environment, the second mode of operation being different from the first mode of operation; receiving, via the user interface, one or more scheduling inputs indicating when the first mode of operation is to be applied in the first area and when the second mode of operation is to be applied in the second area; causing, with the application executed by the communication device, the robot to be instructed to apply the first mode of operation in the first area of the working environment according to at least some of the one or more scheduling inputs; and causing, with the application executed by the communication device, the robot to be instructed to apply the second mode of operation in the second area of the working environment according to at least some of the one or more scheduling inputs, the second mode of operation being applied during a different work session of the robot from a work session in which the first mode of operation is also applied.
5. The medium of embodiment 1, wherein: the first mode of operation is a navigation mode; and the user interface comprises inputs to select among at least: a default navigation mode, a user pattern navigation mode, and an ordered coverage navigation mode.
6. The medium of embodiment 1, wherein: the first set of one or more inputs comprises a first setting to be applied in the first mode of operation, the first setting being one setting among a plurality of settings the robot is capable of applying in the first mode of operation.
7. The medium of embodiment 6, wherein the operations comprise: causing, with the application, the robot to be instructed to apply the first mode of operation in the first area of the working environment with the first setting; and causing, with the application, the robot to be instructed to apply the first mode of operation in a second area of the working environment with a second setting that is different from the first setting during a work session in which the first setting is applied.
8. The medium of embodiment 1, wherein the operations comprise: presenting, in the user interface, inputs by which a phase, frequency, or duty cycle is selected to schedule periodic application of the first mode of operation in the first area of the working environment.
9. The medium of embodiment 8, wherein the operations comprise: presenting, in the user interface, inputs by which a phase, frequency, and duty cycle are selected to schedule periodic application of a second mode of operation in the first area of the working environment.
10. The medium of embodiment 1, wherein the operations comprise: presenting, in the user interface, inputs by which a criterion is at least partially specified to initiate or otherwise schedule application of the first mode of operation in the first area of the working environment, wherein the criterion is conditioned on a phenomenon other than date or time.
11. The medium of embodiment 10, wherein the operations comprise: determining, by the application, that the criterion is satisfied and, in response, causing the robot to initiate or otherwise schedule application of the first mode of operation in the first area of the working environment; determining, by a computer system physically distinct from the robot and the communication device, that the criterion is satisfied and, in response, causing the robot to initiate or otherwise schedule application of the first mode of operation in the first area of the working environment; or determining, by the robot, that the criterion is satisfied and, in response, causing the robot to initiate or otherwise schedule application of the first mode of operation in the first area of the working environment.
12. The medium of embodiment 1, wherein the operations comprise: receiving, via the user interface, inputs that at least partially specify a Boolean statement comprising a plurality of Boolean criteria, Boolean operators, and associations between the Boolean criteria and the Boolean operators; and causing the robot to initiate or otherwise schedule application of the first mode of operation in the first area of the working environment in response to the Boolean statement evaluating to a specified Boolean result.
13. The medium of embodiment 1, wherein: the robot is a cleaning robot; and the first mode of operation, or a setting thereof received via the user interface, specifies an intensity of cleaning to be applied by the robot.
14. The medium of embodiment 1, wherein the application, when executed, is capable of causing the robot to apply at least four of the following modes of operation: a select mode; a cleaning mode; a universal serial bus connecting mode; a WiFi connecting mode; a Bluetooth pairing mode; a radio frequency synchronizing mode; a return mode; a checkup mode; a docking mode; a screen saver mode; a charging mode; an error mode; an unlocking mode; a cloud-uploading mode; a reporting mode; or a diagnostic mode.
15. The medium of embodiment 1, wherein the application, when executed, is capable of causing a finite state machine of the robot to apply at least 14 of the following modes of operation: a select mode; a cleaning mode; a universal serial bus connecting mode; a WiFi connecting mode; a Bluetooth pairing mode; a radio frequency synchronizing mode; a return mode; a checkup mode; a docking mode; a screen saver mode; a charging mode; an error mode; an unlocking mode; a cloud-uploading mode; a reporting mode; or a diagnostic mode.
16. The medium of embodiment 1, wherein: the robot is a floor cleaning robot comprising a vacuum; and the robot is capable of simultaneous localization and mapping.
17. The medium of embodiment 16, wherein: the application connects directly to the robot via a local wireless network without routing communications via the Internet.
18. The medium of embodiment 1, wherein the operations comprise: determining a suggested adjustment to a boundary of the map; presenting, with by the application executed by the communication device, via the user interface, the suggested adjustment to the boundary; receiving, via the user interface, a request to apply the suggested adjustment to boundary to the map; and in response to receiving the request, causing an updated map to be obtained by the robot, wherein the updated map includes the suggested adjustment to the boundary of the map.
19. The medium of embodiment 1, wherein the operations comprise: visually designating a second area of the working environment as having been covered by the robot in the user interface; and visually designating a third area of the working environment as having not been covered by the robot in the user interface.
20. The medium of embodiment 1, wherein the operations comprise: visually depicting, with the user interface, a planned path of the robot through the working environment.
21. The medium of embodiment 1, wherein the operations comprise: visually designating, in the user interface, a next area of the working environment to be covered by the robot.
22. The medium of embodiment 1, wherein the operations comprise: obtaining a starting location and a destination in the working environment; determining a plurality of candidate routes from the starting location to the destination; displaying, with the user interface, the plurality of candidate routes from the starting location to the destination; receiving, with the user interface, a selection of one of the candidate routes; and in response to receiving the selection, causing the robot to traverse the selected one of the candidate routes.
23. The medium of embodiment 1, wherein the operations comprise: determining a rotational adjustment to display the map or a boundary thereof; and displaying the map or boundary thereof with the rotation on a touchscreen of the communication device by which inputs are received.
19. A method, comprising: the operations of any one of embodiments 1-23.

We claim:

1. A tangible, non-transitory, machine-readable medium storing instructions that when executed by one or more processors effectuate operations comprising:
obtaining, with an application executed by a communication device, from a robot that is physically separate from the communication device, a map of a working environment of the robot, the map being based on data sensed by the robot while traversing the working environment;
presenting, with the application executed by the communication device, a user interface having inputs by which, responsive to user inputs, modes of operation of the robot are assigned to areas of the working environment depicted in the user interface;
receiving, with the application executed by the communication device, a first set of one or more inputs via the user interface, wherein the first set of one or more inputs:
designate a first area of the working environment, and
designate a first mode of operation of the robot to be applied in the designated first area of the working environment; and
after receiving the first set of one or more inputs, causing, with the application executed by the communication device, the robot to be instructed to apply the first mode of operation in the first area of the working environment.

2. The medium of claim 1, wherein the operations comprise:
receiving, with the application executed by the communication device, a second set of one or more inputs via the user interface, wherein the second set of one or more inputs:
designate a second area of the working environment, the second area being different from the first area, and
designate a second mode of operation of the robot to be applied in the designated first area of the working environment, the second mode of operation being different from the first mode of operation;
after receiving the second set of one or more inputs, causing, with the application executed by the communication device, the robot to be instructed to apply the second mode of operation in the second area of the working environment, the second mode of operation being applied during a work session of the robot in which the first mode of operation is also applied in the first area of the working environment.

3. The medium of claim 1, wherein:
the user interface has inputs by which application of modes of operation to areas of the working environment are scheduled; and
the operations comprise:
receiving, via the user interface, in the first set of one or more inputs, or in another set of one or more inputs, an input indicating when the first mode of operation is to be applied in the first area; and
causing, with the application executed by the communication device, the robot to be instructed to apply the first mode of operation in the first area of the working environment according to the input indicating when the first mode of operation is to be applied in the first area of the working environment.

4. The medium of claim 1, wherein the operations comprise:
receiving, with the application executed by the communication device, a second set of one or more inputs via the user interface, wherein the second set of one or more inputs:
designate a second area of the working environment, the second area being different from the first area, and
designate a second mode of operation of the robot to be applied in the second area of the working environment, the second mode of operation being different from the first mode of operation;
receiving, via the user interface, one or more scheduling inputs indicating when the first mode of operation is to be applied in the first area and when the second mode of operation is to be applied in the second area;
causing, with the application executed by the communication device, the robot to be instructed to apply the first mode of operation in the first area of the working environment according to at least some of the one or more scheduling inputs; and
causing, with the application executed by the communication device, the robot to be instructed to apply the second mode of operation in the second area of the working environment according to at least some of the one or more scheduling inputs, the second mode of operation being applied during a different work session of the robot from a work session in which the first mode of operation is applied.

5. The medium of claim 1, wherein:
the first mode of operation is a navigation mode; and
the user interface comprises inputs to select among at least: a default navigation mode, a user pattern navigation mode, and an ordered coverage navigation mode.

6. The medium of claim 1, wherein:
the first set of one or more inputs comprises a first setting to be applied in the first mode of operation, the first setting being one setting among a plurality of settings the robot is capable of applying in the first mode of operation.

7. The medium of claim 6, wherein the operations comprise:
causing, with the application, the robot to be instructed to apply the first mode of operation in the first area of the working environment with the first setting; and
causing, with the application, the robot to be instructed to apply the first mode of operation in a second area of the working environment with a second setting that is different from the first setting during a work session in which the first setting is applied.

8. The medium of claim 1, wherein the operations comprise:
presenting, in the user interface, inputs by which a phase, frequency, or duty cycle is selected to schedule periodic application of the first mode of operation in the first area of the working environment.

9. The medium of claim 8, wherein the operations comprise:
presenting, in the user interface, inputs by which a phase, frequency, and duty cycle are selected to schedule periodic application of a second mode of operation in the first area of the working environment.

10. The medium of claim 1, wherein the operations comprise:
presenting, in the user interface, inputs by which a criterion is at least partially specified to initiate or otherwise schedule application of the first mode of operation in the first area of the working environment, wherein the criterion is conditioned on a phenomenon other than date or time.

11. The medium of claim 10, wherein the operations comprise:
determining, by the application, that the criterion is satisfied and, in response, causing the robot to initiate or otherwise schedule application of the first mode of operation in the first area of the working environment;
determining, by a computer system physically distinct from the robot and the communication device, that the criterion is satisfied and, in response, causing the robot to initiate or otherwise schedule application of the first mode of operation in the first area of the working environment; or
determining, by the robot, that the criterion is satisfied and, in response, causing the robot to initiate or otherwise schedule application of the first mode of operation in the first area of the working environment.

12. The medium of claim 1, wherein the operations comprise:
receiving, via the user interface, inputs that at least partially specify a Boolean statement comprising a plurality of Boolean criteria, Boolean operators, and associations between the Boolean criteria and the Boolean operators; and
causing the robot to initiate or otherwise schedule application of the first mode of operation in the first area of the working environment in response to the Boolean statement evaluating to a specified Boolean result.

13. The medium of claim 1, wherein:
the robot is a cleaning robot; and
the first mode of operation, or a setting thereof received via the user interface, specifies an intensity of cleaning to be applied by the robot.

14. The medium of claim 1, wherein the application, when executed, is capable of causing the robot to apply at least four of the following modes of operation:
a select mode;
a cleaning mode;
a universal serial bus connecting mode;
a WiFi connecting mode;
a Bluetooth pairing mode;
a radio frequency synchronizing mode;
a return mode;
a checkup mode;
a docking mode;
a screen saver mode;
a charging mode;
an error mode;
an unlocking mode;
a cloud-uploading mode;
a reporting mode; or
a diagnostic mode.

15. The medium of claim 1, wherein the application, when executed, is capable of causing a finite state machine of the robot to apply at least 14 of the following modes of operation:
a select mode;
a cleaning mode;
a universal serial bus connecting mode;
a WiFi connecting mode;
a Bluetooth pairing mode;
a radio frequency synchronizing mode;
a return mode;
a checkup mode;
a docking mode;
a screen saver mode;
a charging mode;
an error mode;
an unlocking mode;
a cloud-uploading mode;
a reporting mode; or
a diagnostic mode.

16. The medium of claim 1, wherein:
the robot is a floor cleaning robot comprising a vacuum; and
the robot is capable of simultaneous localization and mapping.

17. The medium of claim 16, wherein:
the application connects directly to the robot via a local wireless network without routing communications via the Internet.

18. The medium of claim 1, wherein the operations comprise:
determining a suggested adjustment to a boundary of the map;
presenting, with by the application executed by the communication device, via the user interface, the suggested adjustment to the boundary;
receiving, via the user interface, a request to apply the suggested adjustment to boundary to the map; and
in response to receiving the request, causing an updated map to be obtained by the robot, wherein the updated map includes the suggested adjustment to the boundary of the map.

19. The medium of claim 1, wherein the operations comprise:
steps for providing a user interface.

20. The medium of claim 1, wherein the operations comprise:
displaying, with the user interface, a path that the robot has taken from one location to another location in the working environment.

21. The medium of claim 1, wherein the operations comprise:
visually designating a second area of the working environment as having been covered by the robot in the user interface; and
visually designating a third area of the working environment as having not been covered by the robot in the user interface.

22. The medium of claim 1, wherein the operations comprise:
visually depicting, with the user interface, a planned path of the robot through the working environment.

23. The medium of claim 1, wherein the operations comprise:
visually designating, in the user interface, a next area of the working environment to be covered by the robot.

24. The medium of claim 1, wherein the operations comprise:
obtaining a starting location and a destination in the working environment;
determining a plurality of candidate routes from the starting location to the destination;
displaying, with the user interface, the plurality of candidate routes from the starting location to the destination;
receiving, with the user interface, a selection of one of the candidate routes; and
in response to receiving the selection, causing the robot to traverse the selected one of the candidate routes.

25. The medium of claim 1, wherein the operations comprise:
steps for removing artifacts and clutter from the map.

26. The medium of claim 1, wherein the operations comprise:
determining a rotational adjustment to display the map or a boundary thereof; and
displaying the map or boundary thereof with the rotation on a touchscreen of the communication device by which inputs are received.

27. A method, comprising:
obtaining, with an application executed by a communication device, from a robot that is physically separate from the communication device, a map of a working environment of the robot, the map being based on data sensed by the robot while traversing the working environment;
presenting, with the application executed by the communication device, a user interface having inputs by which, responsive to user inputs, modes of operation of the robot are assigned to areas of the working environment depicted in the user interface;
receiving, with the application executed by the communication device, a first set of one or more inputs via the user interface, wherein the first set of one or more inputs:
designate a first area of the working environment, and
designate a first mode of operation of the robot to be applied in the designated first area of the working environment; and
after receiving the first set of one or more inputs, causing, with the application executed by the communication device, the robot to be instructed to apply the first mode of operation in the first area of the working environment.
